(19) United States
(12) Patent Application Publication
(10) Pub. No.: US 2014/0126697 A1
(43) Pub. Date: May 8, 2014

(54) RADIATION GENERATING APPARATUS, RADIATION PHOTOGRAPHING SYSTEM, AND SIGHTING PROJECTOR UNIT INCLUDED THEREIN

(71) Applicant: CANON KABUSHIKI KAISHA, Tokyo (JP)

(72) Inventors: Yasuo Ohashi, Kawasaki-shi (JP); Kazuyuki Ueda, Tokyo (JP)

(21) Appl. No.: 14/066,361

(22) Filed: Oct. 29, 2013

(30) Foreign Application Priority Data
Nov. 2, 2012 (JP) 2012-242634

(51) Int. Cl. G21K 1/04

(52) U.S. Cl. CPC G21K 1/04
USPC 378/62; 378/145

(57) ABSTRACT

A radiation generating apparatus includes a radiation generating unit which emits radiation from a focal point thereof; and a sighting projector unit including a reflector plate, a visible light source configured to irradiate the reflector plate with visible light, and a movable diaphragm configured to adjust an opening size of an aperture portion formed by a plurality of restriction blades. The reflector plate is composed of a concave mirror used to allow transmission of the radiation therethrough, and to form a visible-light-irradiated field by reflecting visible light from the visible light source in the direction of the aperture portion.

### BACKGROUND OF THE INVENTION

1. Field of the Invention

This disclosure is related to a radiation generating apparatus having a function of performing simulated display of a radiation-irradiated field with a visible-light-irradiated field, a radiation photographing system using the radiation generating apparatus, and a sighting projector unit to be used for forming the visible-light-irradiated field.

2. Description of the Related Art

A radiation generating apparatus typically includes a radiation generating unit having a radiation generating tube included therein and an adjustable diaphragm unit provided on a front surface of a release window of the radiation generating unit. The adjustable diaphragm unit has a function of adjusting a radiation field (the radiation-irradiated field), by shielding a portion of the radiation field. Specifically, a portion of radiation emitted via the release window of the radiation generating apparatus, which is not necessary for photographing, is blocked by the diaphragm unit so as to reduce exposure of a test body to the radiation. The adjustment of the radiation-irradiated field is achieved by adjusting the size of an aperture portion which is formed by the restriction blades and allows the radiation to pass through. The adjustable diaphragm unit is typically provided with a sighting projector unit configured to perform simulated display of the radiation-irradiated field with the visible-light-irradiated field to allow identification of the field to be irradiated with radiation by the naked eye before photographing.

In the related art, the adjustable diaphragm unit having a typical sighting projector unit is disclosed in Japanese Patent Laid-Open No. 7-148159. The sighting projector unit disclosed in Japanese Patent Laid-Open No. 7-148159 includes a reflector plate configured to allow radiation to pass therethrough and reflect visible light, restriction blades configured to restrict the radiation-irradiated field and the visible-light-irradiated field formed corresponding to the radiation-irradiated field, and a light source configured to emit visible light (a visible light source). The visible light source is arranged at a position deviated from the path of radiation to a field desired to be irradiated so as not to obstruct an optical radiation path when irradiating the field. The reflector plate is a flat mirror, and is arranged obliquely with respect to a center line connecting a focal point of the radiation and a center of the aperture portion of the restriction blades so as to reflect the visible light generated from the visible light source in this arrangement by a reflecting surface and form the visible-light-irradiated field to perform the simulated display of the radiation-irradiated field. The visible light source and the reflector plate are arranged together with the restriction blades within a housing having a radiation shielding property. The housing is formed of a material capable of reducing a radiation hitting the reflector plate or the restriction blades and scattering.

Radiation generated at a radiation generating spot (a focal point of the radiation) passes through the reflector plate and then forms a radiation-irradiated field narrowed to a required range of irradiation by the restriction blades of the adjustable diaphragm unit. The visible light emitted from the visible light source is reflected from the reflecting surface of the reflector plate, and then forms the visible-light-irradiated field narrowed to a required range of irradiation by the restriction blades. In order to enhance the accuracy of the simulated display with the visible-light-irradiated field so that the visible-light-irradiated field is allowed to match the radiation-irradiated field as accurately as possible, it is preferable that the distance from the visible light source to the reflecting surface of the reflector plate match the distance from the focal point of the radiation to the reflecting surface of the reflector plate.

The focal point of the radiation is located at a position in the radiation generating tube stored in the radiation generating unit, and hence there is a certain distance between the focal point and the reflector plate provided on the outside of the radiation generating unit. Therefore, when the distance from the visible light source to the reflecting surface of the reflector plate is allowed to match the distance from the focal point of the radiation to the reflecting surface of the reflector plate, the distance between the visible light source and the reflector plate is increased. Then, the size of the housing of the adjustable diaphragm unit that stores these members is increased, which may prevent reduction in the size of the radiation generating apparatus and of a radiation photographing system using the same. Since the material which constitutes the housing and is capable of diminishing the radiation is a material having a large mass, there arises a problem of increase in weight.

### SUMMARY OF THE INVENTION

The present invention provides a radiation generating apparatus having a radiation generating unit and an adjustable diaphragm unit, and a radiation photographing system using the radiation generating apparatus, which achieve reduction in size and weight.

A first aspect of the invention is a radiation generating apparatus including a radiation generating unit having a focal point where a radiation is released; and a sighting projector unit including a reflector plate, a visible light source configured to irradiate the reflector plate with visible light, and a movable diaphragm configured to be capable of adjusting an opening size of an aperture portion by a plurality of restriction blades, the sighting projector unit being arranged forward of the focal point. The reflector plate is composed of a concave mirror configured to allow the radiation to pass therethrough and arranged at a position traversing a path of the radiation from the focal point to the aperture portion.

A second aspect of the invention is a radiation photographing system including the above-described radiation generating apparatus; a radiation detecting apparatus configured to detect a radiation released from the radiation generating unit and passed through a test body; and a control apparatus configured to control the radiation generating apparatus and the radiation detecting apparatus in coordination with each other.

A third aspect of the invention is a sighting projector unit including a reflector plate, a visible light source configured to irradiate the reflector plate with visible light, and a movable diaphragm configured to be capable of adjusting an opening size of an aperture portion by a plurality of restriction blades and arranged forward of the focal point. The reflector plate is composed of a concave mirror configured to allow the radiation to pass therethrough and arranged at a position traversing a path of the radiation from the focal point to the aperture portion. Further features of the present invention will become apparent from the following description of exemplary embodiments with reference to the attached drawings.

### BRIEF DESCRIPTION OF THE DRAWINGS

FIG. 1 is a general view illustrating an embodiment of a radiation generating apparatus of this disclosure.

FIG. 2A is an enlarged view of an adjustable diaphragm unit illustrated in FIG. 1 at the time of irradiation of visible light.

FIG. 2B is an enlarged view of the adjustable diaphragm unit illustrated in FIG. 1 at the time of irradiation of a radiation.

FIG. 3A is an explanatory drawing of a reflector plate used in this disclosure and includes a plan view, a left side view, and a front view illustrating a reflector plate in one dimensional curvature.

FIG. 3B is an explanatory drawing of a reflector plate used in this disclosure and illustrates a relationship between a visible-light-irradiated field and a radiation-irradiated field when using the reflector plate illustrated in FIG. 3A.

FIG. 4A is an explanatory drawing of a reflector plate used in this disclosure and includes a plan view, a left side view, and a front view illustrating a reflector plate in a two-dimensional curvature.

FIG. 4B is an explanatory drawing of a reflector plate used in this disclosure and illustrates a relationship between a visible-light-irradiated field and a radiation-irradiated field when using the reflector plate illustrated in FIG. 4A.

FIG. 5A is an explanatory drawing of cross section of the reflector plate used in this disclosure in a state of giving variations to the thickness of a reflecting layer.

FIG. 5B is an explanatory drawing of cross section of the reflector plate used in this disclosure in a state of giving variations both to the reflecting layer and a base material layer.

FIG. 6A is an explanatory drawing of an adjustable diaphragm unit having a sub-reflector plate added to the sighting projector unit and illustrates an example in which a sub-reflector plate composed of a flat mirror is added.

FIG. 6B is an explanatory drawing of an adjustable diaphragm unit having a sub-reflector plate added to the sighting projector unit and illustrates an example in which a sub-reflector plate composed of a concave mirror is added.

FIG. 7 is a drawing illustrating an embodiment of a radiation photographing system of this disclosure.

### DESCRIPTION OF THE EMBODIMENTS

Referring now to the drawings, embodiments of this disclosure will be described. However, this disclosure is not limited to the embodiments described below. As regards portions not specifically illustrated or not described in this specification, known or publicly known technologies of the corresponding technical fields are applied. In the drawings that are referred to below, the same reference numerals indicate the same components.

### Embodiment of Radiation Generating Apparatus

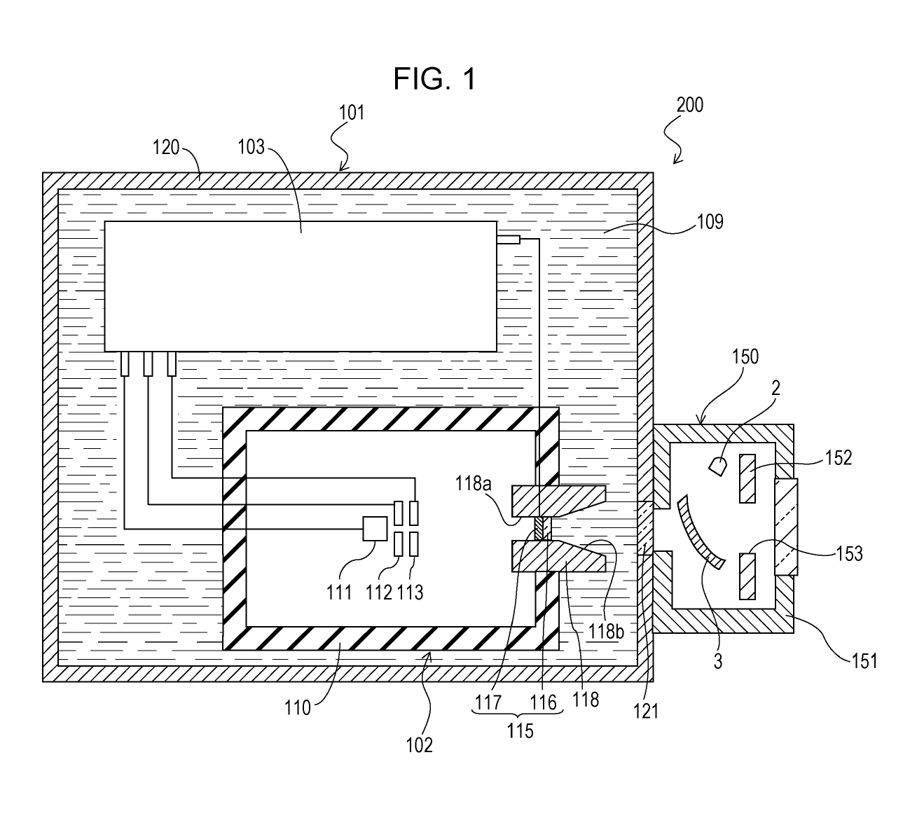

As illustrated in FIG. 1, a radiation generating apparatus 200 of this disclosure includes a radiation generating unit 101 and a sighting projector unit 150.

The radiation generating unit 101 includes a storage container 120, a radiation generating tube 102, and a driving circuit portion 103. The storage container 120 stores the radiation generating tube 102 and the driving circuit portion 103 therein. A remaining space in the interior of the storage container 120 is filled with insulating liquid 109 serving as a medium for cooling the radiation generating tube 102 and the driving circuit portion 103.

The radiation generating tube 102 includes a cathode 111 serving as an electron source, a grid electrode 112, and a lens electrode 113 in a vacuum chamber 110. A target 115 configured to generate radiation by being irradiated with electrons is provided at a position opposing the cathode 111. The radiation generating tube 102 of the embodiment is a transmission-type radiation generating tube using a transmission-type target as the target 115, and the target 115 constitutes a transmission window for causing the radiation to go out of the radiation generating tube 102.

The target 115 includes a supporting substrate 116 and a target layer 117 stacked on the supporting substrate 116. The supporting substrate 116 is formed of a material having good transmissivity for the radiation. For example, a diamond substrate may be used as the supporting substrate 116. The target layer 117 is formed of a material which releases radiation by being irradiated with electrons. The target layer 117 may be formed as a layer of a metal having an atomic number 42 or higher, or as a layer containing the metal. The target 115 is installed with the target layer 117 facing the cathode 111. The target layer 117 is irradiated with electrons which are taken out from the cathode 111 by the grid electrode 112 and accelerated and are converged by the lens electrode 113, whereby the radiation is generated. The radiation generated at target layer 117 passes through the supporting substrate 116 and goes out of the radiation generating tube 102.

A radiation shielding member 118 is provided around the target 115 (transmission window) of the radiation generating tube 102 stored in the storage container 120 so as to project both outward and inward of the radiation generating tube 102. The radiation shielding member 118 is configured to shield unnecessary part of the radiation, and is preferably formed of a material having low radiation transmissivity such as lead or tungsten. The radiation shielding member 118 has a through hole penetrating through the inside-and-outside direction of the radiation generating tube 102. The target 115 is provided in the through hole of the radiation shielding member 118, and shields a midsection of the through hole. The through hole of the radiation shielding member 118 includes an electron incident hole 118a on one side (the inside of the radiation generating tube 102) and a radiation extraction hole 118b on the other side (the outside of the radiation generating tube 102) with respect to the target 115 provided at the midsection of the through hole. The electron incident hole 118a is a hole which allows the target 115 (the target layer 117) to be irradiated with the electrons passing therethrough and faces the cathode 111. The radiation extraction hole 118b is a hole which allows the radiation generated by irradiating the target 115 (the target layer 117) with the electrons to pass therethrough and go out therefrom, and faces the release window 121 of the storage container 120.

The driving circuit portion 103 is arranged inside the storage container 120 of the radiation generating unit 101. The driving circuit portion 103 generates a voltage and the voltage is applied to the cathode 111, the grid electrode 112, the lens electrode 113, and the target layer 117 provided in the radiation generating tube 102. Examples of the cathode 111 include a tungsten filament, a heat cathode such as an impregnated cathode, and a cold cathode such as a cathode made of carbon nanotubes. In the vacuum chamber 110, electrons are discharged in the direction of the target layer 117 as an anode by an electric field formed by the grid electrode 112. The electrons are converged by the lens electrode 113, and collide with the target layer 117 formed on the supporting substrate 116 by a film-forming technology or the like, and generate a radiation. Examples of the target layer 117 include tungsten, tantalum, and molybdenum layers. The generated radiation passes through the release window 121 with unnecessary part thereof being shielded by the radiation shielding member 118. The radiation then passes through the sighting projector unit 150.

The storage container 120 is filled with the insulating liquid 109 serving as a cooling medium for the radiation generating tube 102. The insulating liquid 109 is preferably insulating oil, and mineral oil, silicone oil, or the like. Examples of the other usable insulating liquid 109 include fluorinated insulating liquid.

The sighting projector unit 150 is connected to the release window 121 of the radiation generating unit 101, and in this embodiment, includes restriction blades 152 and a housing 151.

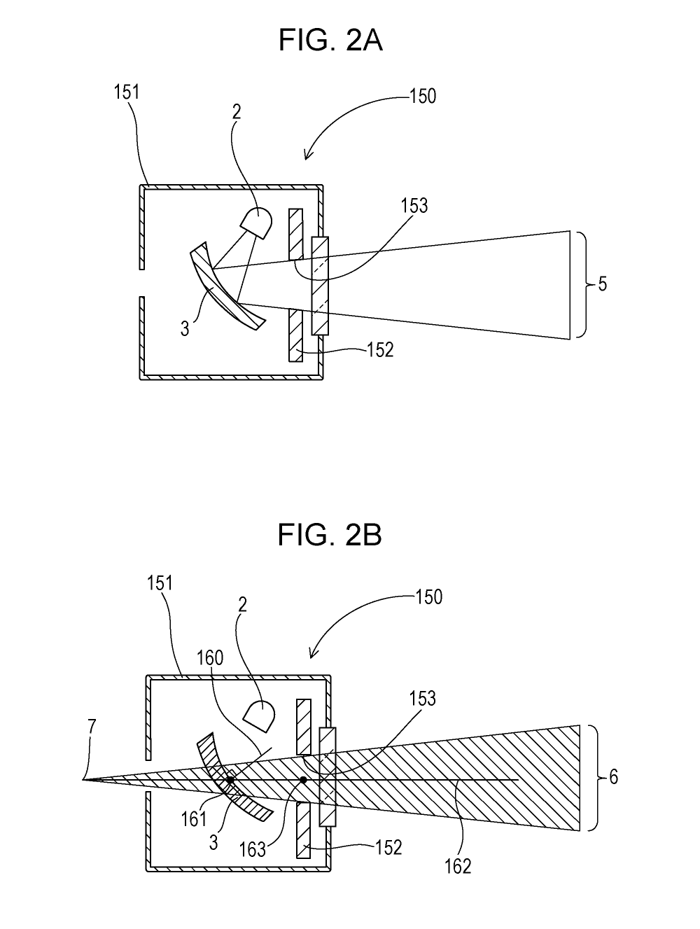

As illustrated in FIGS. 2A and 2B, the restriction blades 152 are provided to form an aperture portion 153 which allows the radiation to pass therethrough. The size of the radiation-irradiated field 6 (see FIG. 2B) is adjustable by adjusting the size of the aperture portion 153 using the restriction blades 152. The restriction blades 152 are formed with a material having a radiation-shielding property such as lead, tungsten, and molybdenum, so as to be capable of shielding the unnecessary radiation and defining the radiation-irradiated field 6 having a desired size. The restriction blades 152 also restrict the visible light simultaneously.

The housing 151 is an outer frame that is connected to the radiation generating unit 101 and contains the restriction blades 152 and the sighting projector unit while shielding the scattering radiation. The housing 151 is formed of the same material as the housing used in the related art. In order to suppress scattering of the visible light emitted from the visible light source 2, the housing 151 is preferably blackened by coating, chemical treatment, or the like for reducing a reflectance on the inner surface of the container with respect to the visible light.

The sighting projector unit 150 is provided with the sighting projector unit. The sighting projector unit includes the visible light source 2 and the reflector plate 3, and is configured to perform display of visible light which simulates the radiation-irradiated field 6 at the time of irradiation of a radiation using the visible-light-irradiated field 5 by the visible light (see FIG. 2A). The visible light source 2 is configured to emit visible light for realizing the visible-light-irradiated field 5, and is not specifically limited as long as light visible to the human eye is emitted, any light source can be used. A light-emitting diode (LED), a laser visible light source, or the like is preferably used because of its compact size which does not need a large installation space.

The visible light source 2 irradiates the outside with the visible light emitted therefrom through the aperture portion 153 via the reflector plate 3. Therefore, the visible light source 2 is installed so as to face the reflecting surface of the reflector plate 3. Specifically, in this disclosure, a concave mirror is used as the reflector plate 3. Since the concave mirror has an advantage in converging and reflecting incident light, even though the distance from the visible light source 2 to the reflecting surface of the reflector plate 3 is reduced, the same state of reflecting light as in a case where the distance from the visible light source 2 to the reflecting surface of the reflector plate 3 is increased may be obtained. In order to enhance the accuracy of the simulated display with the sighting projector unit using the reflector plate composed of the flat mirror of the related art, the distance between the focal point of the radiation and the reflecting surface of the reflector plate and the distance between the visible light source and the reflecting surface of the reflecting plate need to be equalized or made as close as possible. In the sighting projector unit of this disclosure, since the concave mirror is used as the reflector plate 3, even when the position of the visible light source 2 is moved toward the reflecting surface, the state of the reflected light is the same as the state in the case where the visible light source 2 is moved away from the reflecting surface, and the accuracy of the simulated display may be maintained at a high level. When the concave mirror is used as the reflector plate 3, since light is converged, and hence the intensity of illumination of the visible-light-irradiated field is increased and a half shadow of the visible light source 2 is reduced, so that the boundary of the visible-light-irradiated field 5 may be further clarified.

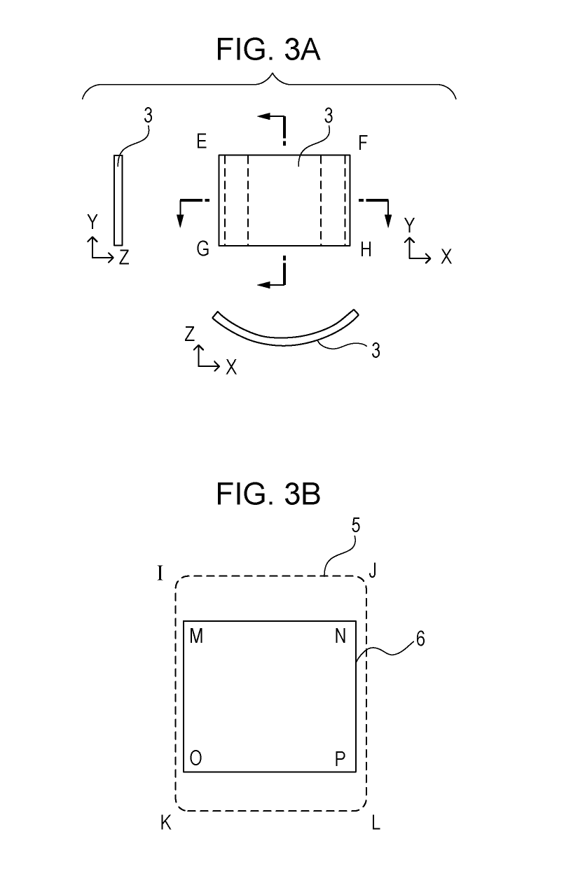

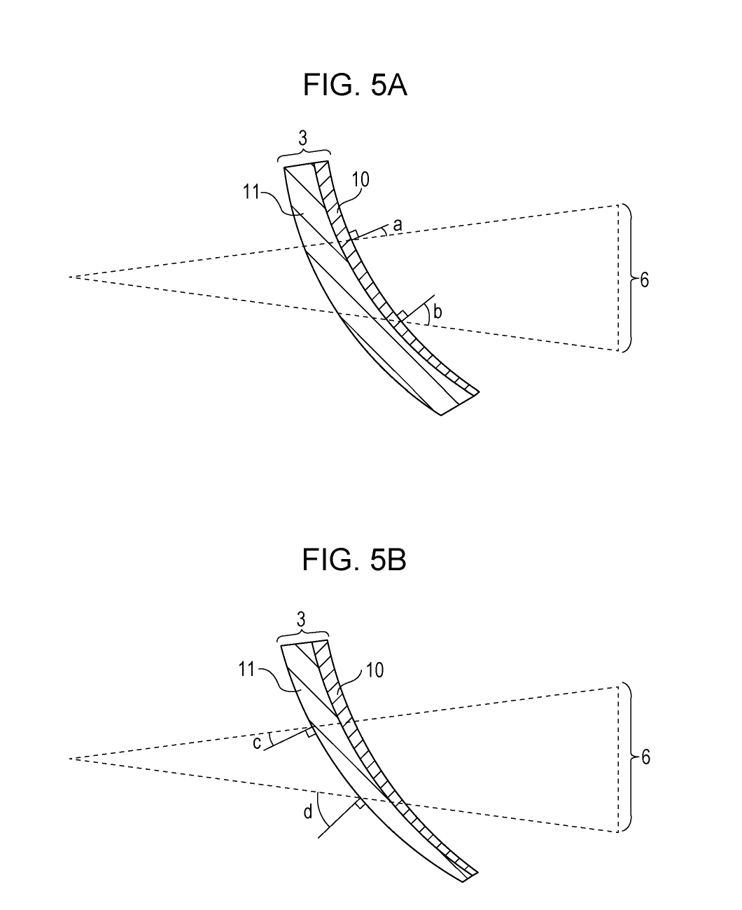

The reflector plate 3 composed of the concave mirror of this disclosure is provided so as to traverse a path of the radiation between the release window 121 of the radiation generating unit 101 and the aperture portion 153 of the restriction blades 152 in the same manner as the reflecting plate composed of the flat mirror of the related art. As illustrated in FIGS. 5A and 5B, a reflecting layer 10 is typically formed on one surface of a transparent base layer 11, and allows the radiation to pass therethrough and the visible light to be reflected by the reflecting surface. The concave mirror used as the reflector plate 3 of this disclosure may be the one curved in the X-direction and not curved in the Y-direction, that is, having one-dimensional curve (U-shaped curve) as illustrated in FIG. 3A, or a two-dimensional curve (bowl-shaped curve) curved both in the X-direction and the Y-direction.

The reflector plate 3 illustrated in FIG. 3A is the one curved one-dimensionally in the X-direction, and hence the visible-light-irradiated field 6 is expanded in the Y-direction, but is not expanded in the X-direction, resulting in the deviation between the radiation-irradiated field 5 and the visible-light-irradiated field 6 in the Y-direction. However, when the radiation generating apparatus 200 is used for an application in which such a displacement does not pose any impediment, the reflector plate 3 having a simple curved state is used, whereby the radiation generating apparatus 200 easy to manufacture with reduced cost is achieved.

A case will be described with reference to FIG. 3B where the radiation generating apparatus 200 using the reflector plate 3 composed of the concave mirror having one-dimensional curve illustrated in FIG. 3A is applied to mammography. A case is assumed where the chest portion of a test body, not illustrated, is positioned on the outside of a M-O side of the radiation-irradiated field 6, and a breast, not illustrated, is positioned within the radiation-irradiated field 6 across the M-O side for photographing. In the case of this positional relationship, the error between the visible-light-irradiated field 5 and the radiation-irradiated field 6 on the M-N side and on the O-P side, where the test body is not positioned, may be controlled less strictly as compared to the error with respect to the side of the M-O side. Therefore, in this application, the reflector plate 3 as illustrated in FIG. 3A may be used. Furthermore, the visible-light-irradiated field 5 equivalent to the radiation-irradiated field 6 may be obtained by arranging, separately from the restriction blades 152 which restrict the radiation, restriction blades which allow the radiation to pass therethrough, but restrict the passage of the visible light in the sighting projector unit 150 and by restricting the visible right.

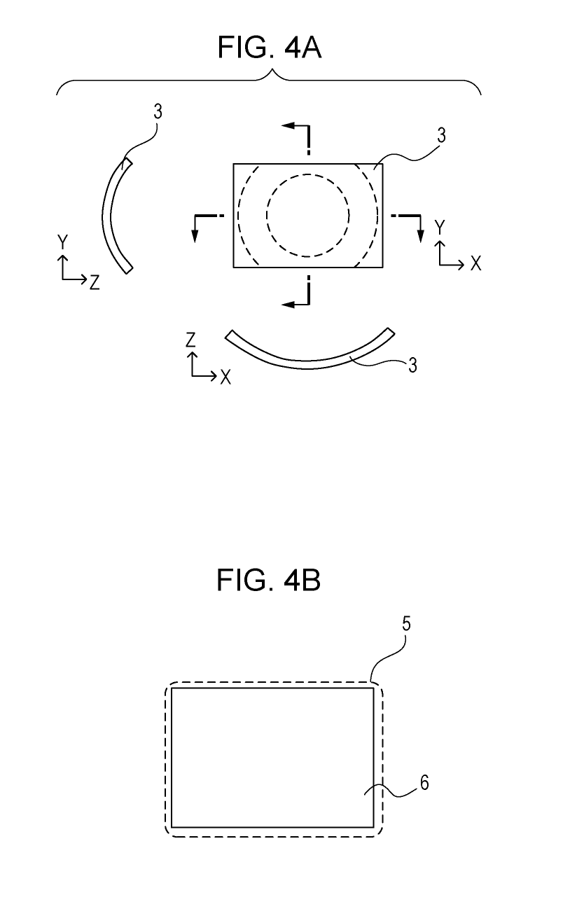

In a case where the concave mirror having the two-dimensional curve as illustrated in FIG. 4A is used as the reflector plate 3, the visible-light-irradiated field 5 having the same size and shape as the radiation-irradiated field 6 may be preferably realized as illustrated in FIG. 4B. In addition, the concave mirror having the two-dimensional curve is the concave mirror having a rotating secondary curved surface and specifically has a concave reflecting surface having a shape formed by rotating a curve such as a parabolic line, an oval arc, an arc, or the like.

The reflector plate 3 is provided so as to be capable of reflecting the visible light from the visible light source 2 in the direction of the aperture portion 153 of the restriction blades 152 without any obstruction in an optical path of the reflected light with the visible light source 2. Specifically, the reflector plate 3 is provided obliquely with respect to a straight line (center line 162) connecting a focal point 7 of the radiation (see FIG. 2B) and the center 163 of the aperture portion 153 of the fully-opened restriction blades 152. The term “the focal point 7 of the radiation” means the center of the radiation generating spot, that is, the center of the electron irradiation spot on the target layer 117. The term “the center of the aperture portion 153 of the fully-opened restriction blades 152” means the position of center of gravity of a plate member, which is assumed to have the same shape and size as the aperture portion 153 and have a uniform thickness when the restriction blades 152 determine the maximum radiation-irradiated field 6.

For example, assuming that the angle formed between a normal line 160 at the center 161 of the concave mirror to be used as the reflector plate 3 and the center line 162 is 45 degrees, the size of the housing 151 in the vertical direction on the drawing may be reduced. In addition, since the visible light source 2 may be arranged closer to the reflector plate 3, if the angle formed between the normal line 160 at the center 161 of the concave mirror and the center line 162 is reduced, the visible light source 2 does not obstruct an optical path of the reflected light. Therefore, the angle formed between a normal line 160 at the center 161 of the concave mirror used as the reflector plate 3 and the center line 162 may be set to an angle smaller than 45 degrees, and further the size of the housing 151 in the lateral direction on the drawing may be reduced. In order to reduce the size of the housing 151, the angle formed between the normal line 160 at the center 161 of the concave mirror and the center line 162 is preferably set to an angle not larger than 40 degrees.

By setting the visible light source 2 and the focal point 7 to have an optically conjugated positional relationship, simulated-display of the radiation-irradiated field 6 formed by the focal point 7 on a detector, not illustrated, configured to detect a radiation and provided at a position opposing the sighting projector unit may be achieved with the visible-light-irradiated field 5 formed on the detector by the visible light source 2 with high reproducibility.

The reflector plate 3, which is a concave mirror, may be the one having a uniform thickness. However, the reflecting layer 10 formed of a material of metal or the like having a relatively high capability of diminishing the radiation may have a distribution in the film thickness. Specifically, an angle formed between a normal line at a certain position on the surface of the reflecting layer 10 and a radiation passing through the position of the normal line is defined as “a”, and an angle between a normal line at another position on the surface of the reflecting layer 10 and a radiation passing through this position of the normal line is defined as “b”. When a<b is established, it is preferable that the thickness of the portion of the reflecting layer 10, at the position where the angle “a” is formed, is larger than the thickness of the portion of the reflecting layer 10, at the position where the angle “b” is formed. That is, it is preferable that the portion of the reflecting layer 10 at angle “a” is large and the thickness of the portion of the angle “b” is small. In other words, it is preferable that the thickness of the reflecting layer 10 at a position where the angle formed between the normal line to the surface of the reflecting layer 10 and the direction of transmission of the radiation passing through the position of the normal line is relatively small be larger than the thickness of the reflecting layer 10 at a position where the angle is relatively large. In this configuration, the distance by which the radiation passes through the reflecting layer 10 may be close to uniform, so that unevenness in the quality of radiation passing through the reflector plate 3 may be reduced. When the radiation generating unit 101 is a transmission-type unit using the transmission-type radiation generating tube 102, the quality of the radiation emitted from the radiation generating unit 101 is relatively uniform. Therefore, this configuration is specifically effective for preventing deterioration in the uniformity of the radiation quality.

As illustrated in FIG. 5B, the thickness of the base layer 11 may have a predetermined thickness distribution. In this manner, an angle formed between a normal line at a certain position of the surface of the base layer 11 and a direction of transmission of a radiation passing through the position of the normal line is defined as “c”, and an angle between a normal line at another position of the base layer 11 and a direction of transmission of a radiation passing through this position of the normal line is defined as “d”. When c<d is established, it is preferable that the thickness of the portion of the angle “c” be large and the thickness of the portion of the angle “d” be small. In other words, it is preferable that the thickness of the base layer 11 at a position where the angle formed between the normal line to the surface of the base layer 11 and the direction of transmission of the radiation passing through the position of the normal line is relatively small be larger than the thickness of the base layer 11 at a position where the angle is relatively large. Accordingly, the same effect as the case where the thickness of the reflecting layer 10 is varied is also achieved.

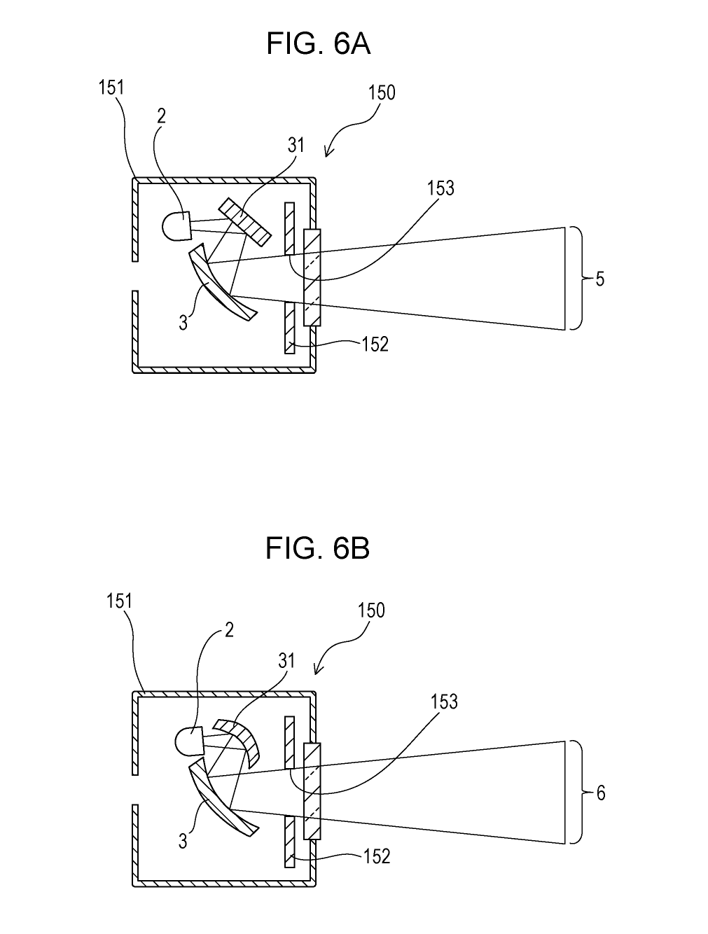

Furthermore, the reflector plate may be varied in the thicknesses of the reflecting layer and the base layer as illustrated respectively in FIG. 5A and FIG. 5B. In such embodiment, it is most preferable that both of the reflecting layer 10 and the base layer 11 be configured to have a uniform radiation transmission distance over an effective area of the concave mirror which constitutes the reflector plate 3. The expression “having a uniform transmission distance” described above means that the product Tr×Ts of a transmissivity Tr of the reflecting layer and a transmissivity Ts of the base layer is uniform irrespective of the position in the reflecting layer. The effective area described above corresponds to the area in which the radiation released from the focal point 7 through the aperture portion 153 intersects the reflector plate 3 under a condition that the opening diameter of the aperture portion 153 in FIG. 2B is maximum. In other words, a portion where the reflector plate 3 intersects the radiation path having a conical shape formed by the aperture portion 153 under the maximum opening condition and the focal point 7 corresponds to the effective area. When the visible light source 2 and the focal point 7 have the above-described optically conjugated positional relationship, the distance between the center of the effective area and the visible light source may be set to be shorter than the distance between the center and the focal point, and the reproducibility of the visible-light-irradiated field with respect to the radiation-irradiated field may be enhanced. The sighting projector unit used in the disclosure only needs to be provided with the visible light source 2 and the reflector plate 3 composed of a concave mirror. However, a sub-reflector plate 31 configured to reflect the visible light from the visible light source 2 to the reflector plate 3 maybe interposed between the visible light source 2 and the reflector plate 3 as illustrated in FIG. 6A and 6B. FIG. 6A illustrates an example in which the sub-reflector plate 31 composed of a flat mirror is interposed, and FIG. 6B illustrates an example in which the sub-reflector plate 31 composed of a concave mirror is interposed. By interposing the sub-reflector plate 31, the visible light source 2 may be arranged easily at a position which is not susceptible to the scattered radiation generated when passing through the reflector plate 3, for example. An LED visible light source provided with a light exciting unit or a laser visible light source or the like composed of a semiconductor device may be subject to damage by the radiation, and hence it is preferable to install the visible light source 2 at a position not susceptible to the scattered radiation by using the sub-reflector plate 31. Since the optical path length from the visible light source 2 to the reflector plate 3 may further be shortened by arranging the sub-reflector plate 31 composed of a concave mirror, and hence further reduction in the size of the housing 151 is achieved.

### Embodiment of Radiation Photographing System

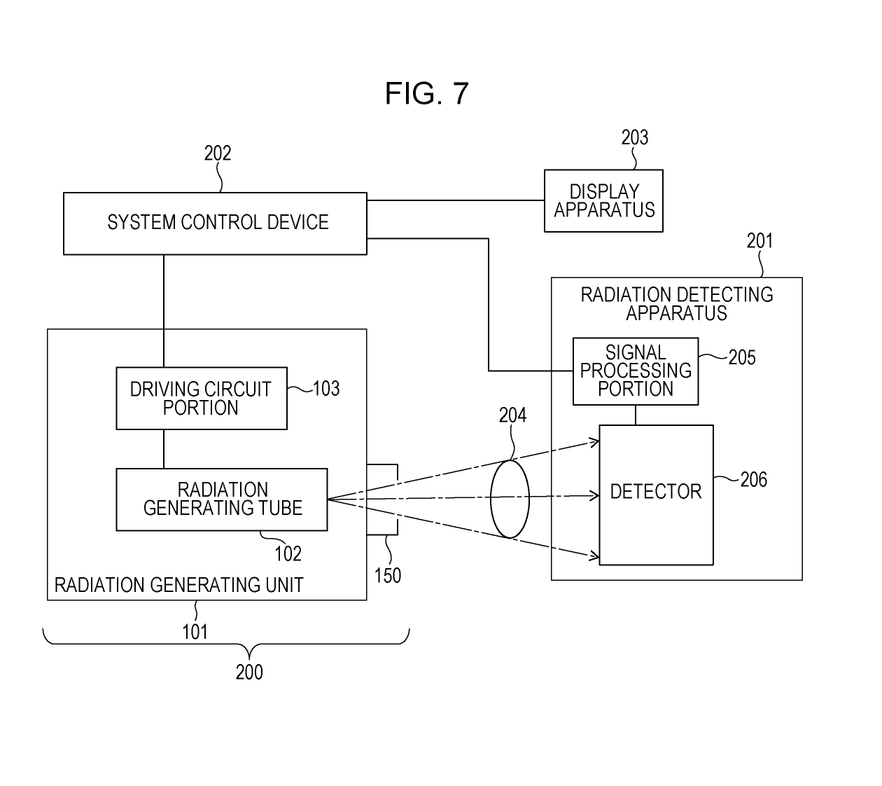

FIG. 7 is a drawing illustrating configuration of a radiation photographing system of this disclosure. A system control apparatus 202 controls the radiation generating apparatus 200 and a radiation detecting apparatus 201 in coordination with each other. The driving circuit portion 103 outputs various control signals to the radiation generating tube 102 under the control of the system control apparatus 202. With the control signal, a state of emission of the radiations emitted from the radiation generating apparatus 200 is controlled. The radiations emitted from the radiation generating apparatus 200 are partly shielded by the sighting projector unit 150 having the aperture portion, pass through a test body 204, and are detected by a detector 206. The detector 206 converts the detected radiations to image signals and outputs the signals to a signal processing unit 205. The signal processing unit 205 performs predetermined signal processing on the image signals under the control of the system control apparatus 202 and outputs the processed image signals to the system control apparatus 202. The system control apparatus 202 outputs a display signal for displaying an image on a display device 203 on the basis of the processed image signal. The display device 203 displays an image based on the display signal on the screen as a photographed image of the test body 204.

An X-ray represents the radiation, and the radiation generating apparatus and the radiation photographing system of this disclosure may be used as an X-ray generating unit and an X-ray photographing system. The X-ray photographing system may be used in a non-destructive inspection for industrial products and used as medical equipment for supporting medical diagnosis of human bodies or animals.

### EXAMPLES

### Example 1

A radiation generating apparatus as illustrated in FIG. 1 and FIGS. 2A and 2B is manufactured.

The size of the housing 151 of the sighting projector unit 150 was 50×50×30 mm, and a resin sheet containing tungsten powder was bonded to the inner surface of the housing 151 so as to prevent scattered radiation leaking therefrom. A visible light source 2 composed of 2 mm×2 mm white chip LED was provided inside of the housing 151. The normal line at the center of the reflector plate 3 of the concave mirror that reflects light from the visible light source 2 was inclined by 35° with respect to the center axis. The concave mirror used as the reflector plate 3 had a magnification of ×1.3 and a diameter of 30 mm. The visible light source 2 was assembled so that the area of the visible light from the visible light source 2 is restricted by the restriction blades 152 arranged inside of the housing 151, thereby forming the visible-light-irradiated field 5.

The thickness of the reflecting layer 10 of the concave mirror was configured to be large at a portion where the angle formed between the normal line to the reflecting layer 10 and the direction of transmission of the radiation which passes through the position of the normal line was small and the thickness thereof be small at a portion where the angle was large, so that the distance of passage of the radiation becomes uniform.

The adjustable diaphragm unit was mounted on the sighting projector unit 150 of the transmission-type radiation generating apparatus 200. When the operation of the radiation photographing system using the radiation generating apparatus 200 was observed, the visible-light-irradiated field 5 substantially same as the radiation-irradiated field 6 was displayed, and variations in the radiation quality were small, and an image having a good image quality was obtained.

With respect to the operation of the adjustable diaphragm unit, the intensity of illumination became brighter than that when using the flat mirror by the lens effect of the concave mirror used as the reflector plate 3, a half shadow of the visible light source 2 became small, and the boundary of the visible-light-irradiated field 5 became clear. When the entire weight of the sighting projector unit 150 was measured, it was about 200 g, and the weight was reduced as compared to the products of the related art.

A sighting projector unit of the related art will be described below as a comparative example. A visible light source in the related art was a tube having a diameter of approximately 20 mm, and had a minimum capacity when arranged with the normal line of the reflector plate composed of the flat mirror arranged obliquely with respect to the center line by 45°. The size of the housing was 200×200×150 mm, and the weight was approximately 2 kg.

When an image was taken by using a transmission-type radiation generating unit, unevenness occurs in radiation quality due to the obliquely arranged reflector plate composed of the flat mirror and an image with a gradation was obtained.

### Example 2

Example 2 will be described with reference to FIG. 6B.

A radiation generating apparatus provided with the sighting projector unit 150 illustrated in FIG. 6B was manufactured. Basically, the sighting projector unit 150 was manufactured in the same manner as in Example 1. The reflector plate 3 composed of a concave mirror is arranged at a position where the radiation passes through, and the reflector plate 3 is arranged so as to guide the visible light from the visible light source 2 by reflecting the light with the sub-reflector plate 31 composed of the concave mirror. The size of the housing 151 was 50×50×35 mm, which is smaller than that of the related art. The white LED serving as the visible light source 2 was arranged on the normal line at the center of the effective area of the reflector plate 3 where relatively less scattering of the radiation occurs and the radiation passes through.

The adjustable diaphragm unit was mounted on the sighting projector unit of the transmission-type radiation generating apparatus. When the operation of the radiation photographing system using the radiation generating apparatus was observed, simulated display of the radiation-irradiated field 6 using the visible-light-irradiated field 5 was achieved with good reproducibility.

With respect to the operation of the adjustable diaphragm unit, the intensity of illumination increases by the lens effect of the reflector plate 3 composed of the concave mirror, the half shadow of the visible light source 2 became small, and the boundary of the visible-light-irradiated field became clearer. When the radiation was released for a long time, deterioration of the resin-made portion of the white LED is less than that in Example 1, and normal illumination for a long time was achieved.

When the entire weight of the sighting projector unit 150 was measured, it was about 200 g, and the weight was reduced as compared to the products of the related art.

The radiation generating apparatus of this disclosure employs the concave mirror serving as the reflector plate. Therefore, the state of the reflected light same as the state in the case of the reflection of light from a visible light source located at a farther position may be obtained by the light converging effect. In other words, in the radiation generating apparatus of this disclosure, even when the distance between the reflecting surface of the reflector plate and the visible light source is set to be shorter than the distance between the reflecting surface of the reflector plate and the focal point of the radiation, the same state of the reflecting light as a case where these distances are matched is obtained. Therefore, even when the accuracy of the simulated display by the visible-light-irradiated field is increased, the size of the movable aperture unit provided with the adjustable diaphragm unit is reduced, so that reduction in size and weight of the entire apparatus may be achieved in association with reduction in size and weight of the housing of the sighting projector unit.

In the radiation photographing system of this disclosure, reduction in size and weight of the entire system may be realized by using the radiation generating apparatus reduced in size and weight.

Furthermore, by using the sighting projector unit of this disclosure, reduction in size and weight of the radiation generating apparatus and the radiation photographing system using the same are realized.

While the present invention has been described with reference to exemplary embodiments, it is to be understood that those embodiments are not intended to be limiting. The scope of the following claims is to be accorded the broadest reasonable interpretation so as to encompass all modifications and equivalent structures and functions.

This application claims the benefit of Japanese Patent Application No. 2012-242634 filed in Nov. 2, 2012, which is hereby incorporated by reference herein in its entirety.

What is claimed is:

1. A radiation generating apparatus comprising:
a radiation generating unit configured to emit radiation from a focal point thereof; and
a sighting projector unit including a reflector plate, a visible light source configured to irradiate the reflector plate with visible light, and a movable diaphragm configured to adjust an opening size of an aperture portion formed by a plurality of restriction blades, the sighting projector unit being arranged forward of the focal point, wherein
the reflector plate is composed of a concave mirror configured to allow transmission of the radiation therethrough and arranged at a position traversing a path of the radiation from the focal point to the aperture portion.

2. The radiation generating apparatus according to claim 1, wherein the reflector plate includes an effective area in a portion traversing the path.

3. The radiation generating apparatus according to claim 1, wherein the concave mirror includes a reflecting surface having a rotating curved surface.

4. The radiation generating apparatus according to claim 1, wherein the concave mirror is arranged so that an angle formed between a normal line at a center of the concave mirror and a center line connecting the focal point and a center of the aperture portion fully-opened is not larger than 40 degrees.

5. The radiation generating apparatus according to claim 2, wherein the concave mirror includes a reflecting layer and a base layer in the effective area, and the thickness of the reflecting layer at a position where the angle formed between the normal line to the surface of the reflecting layer and the direction of transmission of the radiation passing through the position of the normal line is relatively small is set to be larger than the thickness of the reflecting layer at a position where the angle is relatively large.

6. The radiation generating apparatus according to claim 2, wherein the concave mirror includes a reflecting layer and a base layer in the effective area, and the thickness of the base layer at a position where the angle formed between the normal line to the surface of the base layer and the direction of transmission of the radiation passing through the position of the normal line is relatively small is set to be larger than the thickness of the base layer at a position where the angle is relatively large.

7. The radiation generating apparatus according to claim 5, wherein the reflecting layer and the base layer in the effective area have thickness distributions so that the reflecting layer and the base layer have a uniform radiation transmission distance.

8. The radiation generating apparatus according to claim 5, wherein the radiation generating unit includes a transmission-type radiation generating tube.

9. The radiation generating apparatus according to claim 1, wherein a sub-reflector plate configured to reflect visible light from the visible light source to the reflector plate is interposed between the visible light source and the reflector plate.

10. The radiation generating apparatus according to claim 9, wherein the sub-reflector plate is composed of a concave mirror.

11. The radiation generating apparatus according to claim 1, wherein the visible light source and the focal point have an optically conjugated positional relationship.

12. The radiation generating apparatus according to claim 2, wherein the distance between a center of the effective area and the visible light source is shorter than the distance between the center and the focal point.

13. The radiation generating apparatus according to claim 1, wherein the sighting projector unit includes a housing configured to store at least the visible light source and the reflector plate, and an inner surface of the housing is treated to reduce the reflectance with respect to the visible light.

14. A radiation photographing system comprising:
the radiation generating apparatus according to claim 1;
a radiation detecting apparatus configured to detect the radiation released from the radiation generating unit and passed through a test body; and
a control apparatus configured to control the radiation generating apparatus and the radiation detecting apparatus in coordination with each other.

15. A sighting projector unit arranged in front of a focal point of a radiation generating apparatus where a radiation is generated, the radiation generating apparatus including a reflector plate, a visible light source configured to irradiate the reflector plate with visible light, and a movable diaphragm configured to adjust an opening size of an aperture portion formed by a plurality of restriction blades, wherein
the reflector plate is composed a concave mirror configured to allow transmission of the radiation therethrough and arranged at a position traversing a path of the radiation from the focal point to the aperture portion.
